(19) United States
(12) Patent Application Publication
(10) Pub. No.: US 2021/0309851 A1
(43) Pub. Date: Oct. 7, 2021

(54) Binder Composition For Sintering Inorganic Particles and Process For Using Same

(71) Applicant: Celanese International Corporation, Irving, TX (US)

(72) Inventors: Xiaowei Zhang, Union, KY (US); Sung Hye Kim, Cincinnati, OH (US); Christopher McGrady, Walton, KY (US); Xinyu Zhao, Cincinnati, OH (US); Darin Grinsteinner, Fort Mitchell, KY (US)

(21) Appl. No.: 17/175,149

(22) Filed: Feb. 12, 2021

Related U.S. Application Data
(60) Provisional application No. 62/976,623, filed on Feb. 14, 2020.

(51) Int. Cl. C08L 71/02

(52) U.S. Cl. CPC C08L 71/02; C08L 2205/025; C08L 2205/03

(57) ABSTRACT

A binder composition containing a polyoxymethylene polymer combined with one or more plasticizers is disclosed that is well suited for use in powder injection molding processes. The binder composition can be combined with inorganic sinterable particles and melt blended together to form a feedstock. The feedstock can be fed through an injection molding process to form a green body. The binder composition of the present disclosure can be easily removed from the green body by contacting the green body with one or more acids. The resulting brown body can then be fed through a sintering process for producing three-dimensional articles having complex shapes.

### RELATED APPLICATIONS

The present application is based upon and claims priority to U.S. Provisional Patent Application Ser. No. 62/976,623, having a filing date of Feb. 14, 2020, which is incorporated herein by reference.

### BACKGROUND

Powder injection molding generally refers to a process in which a shaped article is produced by injection molding a composition containing a sinterable powder combined with a polymer binder. Through the process, a shaped article is produced. The binder is removed from the shaped article and the sinterable particles are sintered together to produce a finished product. One type of powder injection molding is known as metal injection molding. Metal injection molding is a metal working process in which finely-powdered metal is mixed with a thermoplastic binder material to create a feedstock that is then shaped and solidified using injection molding.

After the thermoplastic binder and sinterable particles have been injection molded, the resulting shaped article is typically referred to as a green body. The polymer binder is then removed and the resulting shaped article is referred to as a brown body. The brown body is then subjected to heat and optionally pressure sufficient to remove any residual binder and to cause the remaining particles to sinter together.

Various different thermoplastic polymers have been used as binders in powder injection molding and metal injection molding processes. For example, in the past, polyolefins, such as polyethylene or polypropylene, have been used as binders. During the process for making the shaped article, the polyolefins were removed from the article by pyrolysis. The use of polyolefins, however, had various different drawbacks. For instance, green bodies made using a polyolefin binder did not have sufficient strength and integrity, which limited the dimensions and tolerances of the final products. In addition, removing the binder by pyrolysis can lead to the buildup of carbon within the part.

In addition to polyolefins, polyoxymethylene polymers have also been used as binders in metal injection molding processes. One advantage to using a polyoxymethylene polymer is that the polymer binder can be removed by acid catalyzed degradation without allowing carbon or other debris to remain within the molded article. During acid catalyzed degradation, the polyoxymethylene polymer is contacted with an acid at elevated temperatures causing chain scission and volatilization of the binder.

Binders used in powder injection molding need to have a relatively high melt flow rate so that the binder and sinterable particles can be fed through an injection molding process. Thus, in the past, polyoxymethylene polymer binders used in powder injection molding typically had a low molecular weight in order to maintain higher melt flow rates. The low molecular weight polymers, however, produce green bodies with less than desirable physical properties. For example, the green bodies typically had high stiffness properties, low impact resistance, and low ductility properties. Thus, a need currently exists for an improved polymer binder for use in powder injection molding, such as metal injection molding, that has improved physical properties, particularly improved impact resistance while still having a relatively high melt flow rate. A need also exists for an improved binder composition that when combined with sinterable particles, can produce green bodies with greater ductility.

### SUMMARY

The present disclosure is generally directed to a binder composition for combining with inorganic sinterable particles for forming shaped articles from the sinterable particles. The binder composition is generally in the form of particles, such as pellets, that are melt blended with the sinterable particles. The resulting blend can be fed to a process for producing shaped articles, such as an injection molding process. For example, the binder composition and the sinterable particles can be melt blended together and formed into pellets that are then fed to an injection molding process.

In accordance with the present disclosure, the binder composition contains a polyoxymethylene polymer blended with a plasticizer. The plasticizer not only improves the overall physical properties of the binder composition but also increases the melt flow rate of the composition. The binder composition of the present disclosure has excellent impact resistance. In addition, when combined with the sinterable particles, the resulting composition has low stiffness and improved ductility.

For example, in one embodiment, the present disclosure is directed to a binder composition for combining with inorganic sinterable particles, such as ceramic particles, metal particles, or mixtures thereof. The binder composition is comprised of a polymer composition containing a polyoxymethylene polymer blended with a plasticizer. In accordance with the present disclosure, the plasticizer comprises a polyalkylene glycol, such as a polyethylene glycol. The polymer composition has a melt flow rate of generally greater than about 48 g/10 min, such as greater than about 50 g/10 min, such as greater than about 55 g/10 min, such as greater than about 60 g/10 min, and generally less than about 200 g/10 min.

The polyalkylene glycol plasticizer as described above can, in one aspect, have a molecular weight of from about 1000 g/mol to about 10,000 g/mol, such as from about 2000 g/mol to about 5000 g/mol. Alternatively, the polyalkylene glycol plasticizer can have a molecular weight of from about 20,000 g/mol to about 50,000 g/mol, such as from about 30,000 g/mol to about 40,000 g/mol. The binder composition can also contain a first polyethylene glycol and a second polyethylene glycol. The first polyethylene glycol can have a molecular weight of from about 1000 g/mol to about 10,000 g/mol and the second polyethylene glycol can have a molecular weight of from about 20,000 g/mol to about 50,000 g/mol. The plasticizer is present in the binder composition generally in an amount from about 2% to about 25% by weight, such as from about 5% to about 15% by weight, such as from about 8% to about 13% by weight.

The polyoxymethylene polymer contained within the binder composition can be a polyoxymethylene copolymer. For example, the polyoxymethylene copolymer can contain a dioxolane comonomer. The dioxolane comonomer can be present in the polyoxymethylene polymer in an amount from about 3.3% to about 4% by weight, such as from about 3.45% to about 3.9% by weight. The polyoxymethylene polymer can have a molecular weight of greater than about 90,000 g/mol, such as greater than about 100,000 g/mol, and generally less than about 200,000 g/mol. The polyoxymethylene polymer can contain —OCH₃ endcaps in an amount less than about 50 mmol/kg, such as in an amount less than about 45 mmol/kg, such as in an amount less than about 40 mmol/kg, and generally in an amount greater than about 10 mmol/kg.

In one aspect, the polyoxymethylene polymer includes —OH terminal groups (terminal hydroxyl groups). The —OH terminal groups can be present in the polyoxymethylene polymer in an amount greater than about 20 mmol/kg, such as in an amount greater than about 30 mmol/kg, such as in an amount greater than about 40 mmol/kg, and generally in an amount less than about 100 mmol/kg. The polyoxymethylene polymer can be present in the binder composition in an amount from about 80% to about 98% by weight.

The present disclosure is also directed to a composition for forming injection molded articles. The composition contains an inorganic sinterable powder comprising metal particles, ceramic particles, or mixtures thereof. The inorganic sinterable powder is present in the composition in an amount from about 50% to about 95% by weight, such as in an amount from about 85% to about 95% by weight. The inorganic sinterable powder is combined with the binder composition as described above. For example, the inorganic sinterable powder can be melt blended with the binder composition. In one aspect, the inorganic sinterable powder and the binder can be melt blended to form pellets that are well suited for being fed into an injection molding process.

In one embodiment, the inorganic sinterable powder contains metal particles. The metal particles can contain aluminum, iron, chromium, cobalt, copper, nickel, silicon, titanium, tungsten, or mixtures thereof. In one embodiment, the metal particles are stainless steel particles. The inorganic sinterable particles can have a volume based median particle size of from about 0.1 micron to about 50 microns.

When combined with a binder composition in accordance with the present disclosure, the resulting composition containing the inorganic sinterable powder can have excellent physical properties. For instance, the resulting composition can display a bending deflection of greater than about 1.6 mm, such as greater than about 2 mm, such as greater than about 3 mm, such as greater than about 4 mm, and generally less than about 10 mm. Bending deflection can be measured using ASTM Test D790-07, Procedure B.

The present disclosure is also directed to a process for producing shaped articles. The process includes injection molding an article from the composition as described above containing the inorganic sinterable powder in combination with the binder composition. The composition is molded into an article to form a green body. A substantial portion of the binder composition, such as greater than about 90%, such as greater than about 95%, such as greater than about 98% by weight of the binder composition is then removed from the green body by contacting the green body with an acid to form a brown body. The acid, for instance, may comprise phthalic acid, benzoic acid, or mixtures thereof. The green body can be contacted with the acid while the acid is in a gaseous or liquid state. Removal of the binder can occur at a temperature of from about 30° C. to about 160° C.

Optionally, after the green body is contacted with the acid, the resulting brown body can be subjected to a thermal cycle for removing any residual binder remaining within the article. Thermal treatment, for instance, can occur at a temperature of from about 200° C. to about 650° C.

After the binder is removed from the article, the inorganic sinterable particles are subsequently sintered to form the shaped article.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a diagram illustrating one embodiment for forming a feedstock for use in a powder injection molding process; and

FIG. 2 is a diagram illustrating one embodiment of forming a powder injection molded article in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

The present disclosure is generally directed to a polymer composition containing a polyoxymethylene polymer combined with one or more plasticizers. The polymer composition is formulated so that it is well suited for use as a binder in a powder injection molding, such as a metal injection molding, process. In particular, the polymer composition has a relatively high melt flow rate in conjunction with excellent physical properties that makes the composition well suited for forming pre-sintered articles containing metal or ceramic particles. The pre-sintered article has sufficient strength and other properties that allow the article to be manipulated prior to sintering. In addition, the binder composition of the present disclosure is also easily removed from the pre-sintered article prior to sintering. For example, the binder composition can be formulated such that the binder composition is amenable to an acid catalyzed chain scission process for removing the binder composition from the pre-sintered article.

The binder composition containing the polyoxymethylene polymer with one or more plasticizers also produces a composition having dramatically improved properties when combined with sinterable particles for use in a powder injection molding process. The binder composition of the present disclosure, for instance, when combined with sinterable particles, can produce pre-sintered articles having good toughness and dramatically improved ductility.

Powder injection molding generally refers to a process in which finely-powdered metal or ceramic particles are mixed with a binder mixture to create a feed stock that is then shaped and solidified for use in injection molding. When the finely-powdered particles are metallic particles, the process is generally referred to as metal injection molding. Through the use of the binder composition of the present disclosure, geometrically challenging articles or components can be manufactured economically through the injection molding and sintering process. The binder composition of the present disclosure, for instance, allows for a high level of automation and the formation of articles with a wide variety of shapes. Articles can be produced, for instance, having near-net-shape requirements with good mechanical properties. Further, the binder composition is easily removed from the pre-sintered article through an acid catalyzed degradation process.

The powder injection molding process of the present disclosure can be used in all different fields and in a wide variety of applications. For instance, the powder injection molding process can be used to produce components for communication/electronic products, automotive products, medical products, military products, consumer products, in addition to mechanically engineered products that require high tolerances. Products that can be made in accordance with the present disclosure include housings for mobile phones, housings for engine parts, battery locks, gear box parts, pressure sensor parts, fuel injector parts, in addition to various other mobile device parts, such as SIM card holders.

The binder composition of the present disclosure is generally in the form of particles that are melt blended with inorganic sinterable particles. For example, the binder composition can be a polymer resin in a form that is well suited for being fed to an extruder. The binder composition, for instance, can be in the form of pellets, flakes, a powder, or the like. The binder composition is fed to an extruder and, in one embodiment, melt blended with inorganic sinterable particles.

As described above, the polymer composition of the present disclosure used to produce the binder composition particles generally contains a polyoxymethylene polymer combined with one or more plasticizers.

The polyoxymethylene polymer incorporated into the polymer composition can comprise a polyoxymethylene homopolymer or a polyoxymethylene copolymer.

The preparation of the polyoxymethylene polymer can be carried out by polymerization of polyoxymethylene-forming monomers, such as trioxane or a mixture of trioxane and a cyclic acetal such as dioxolane in the presence of a molecular weight regulator, such as a glycol. According to one embodiment, the polyoxymethylene is a homo- or copolymer which comprises at least 50 mol. %, such as at least 75 mol. %, such as at least 90 mol. % and such as even at least 97 mol. % of —CH₂O-repeat units.

In one embodiment, a polyoxymethylene copolymer is used. The copolymer can contain from about 0.1 mol. % to about 20 mol. % and in particular from about 0.5 mol. % to about 10 mol. % of repeat units that comprise a saturated or ethylenically unsaturated alkylene group having at least 2 carbon atoms, or a cycloalkylene group, which has sulfur atoms or oxygen atoms in the chain and may include one or more substituents selected from the group consisting of alkyl cycloalkyl, aryl, aralkyl, heteroaryl, halogen or alkoxy. In one embodiment, a cyclic ether or acetal is used that can be introduced into the copolymer via a ring-opening reaction.

Preferred cyclic ethers or acetals are those of the formula:

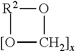

in which x is 0 or 1 and R² is a C₂-C₄-alkylene group which, if appropriate, has one or more substituents which are C₁-C₄-akyl groups, or are C₁-C₄-alkoxy groups, and/or are halogen atoms, preferably chlorine atoms. Merely by way of example, mention may be made of ethylene oxide, propylene 1,2-oxide, butylene 1,2-oxide, butylene 1,3-oxide, 1,3-dioxane, 1,3-dioxolane, and 1,3-dioxepan as cyclic ethers, and also of linear oligo- or polyformals, such as polydioxolane or polydioxepan, as comonomers. It is particularly advantageous to use copolymers composed of from 99.5 to 95 mol. % of trioxane and of from 0.5 to 5 mol. %, such as from 0.5 to 4 mol. %, of one of the above-mentioned comonomers. For example, the polyoxymethylene copolymer can contain a comonomer, such as dioxolane, in an amount greater than about 3.3% by weight, such as in an amount greater than about 3.45% by weight, and generally in an amount less than about 4% by weight, such as in an amount less than about 3.9% by weight.

The polymerization can be effected as precipitation polymerization or in the melt. By a suitable choice of the polymerization parameters, such as duration of polymerization or amount of molecular weight regulator, the molecular weight and hence the MVR value of the resulting polymer can be adjusted.

In one embodiment, the polyoxymethylene polymer is formulated so as to contain relatively low amounts of —OCH₃ endcaps. For example, the polyoxymethylene polymer can contain —OCH₃ endcaps in an amount less than about 50 mmol/kg, such as in an amount less than about 45 mmol/kg, such as in an amount less than about 40 mmol/kg, such as in an amount less than about 35 mmol/kg, such as in an amount less than about 30 mmol/kg, such as in an amount less than about 25 mmol/kg, such as in an amount less than about 20 mmol/kg. The —OCH₃ endcaps are generally present in an amount greater than about 5 mmol/kg, such as greater than about 10 mmol/kg.

In one embodiment, the polyoxymethylene polymer can have terminal hydroxyl groups, for example hydroxyethylene groups and/or hydroxyl side groups, on at least more than about 50% of all the terminal sites on the polymer. For instance, the polyoxymethylene polymer may have at least about 70%, such as at least about 80%, such as at least about 85% of its terminal groups be hydroxyl groups, based on the total number of terminal groups present. It should be understood that the total number of terminal groups present includes all side terminal groups.

In one embodiment, the polyoxymethylene polymer has a content of terminal hydroxyl groups of at least 15 mmol/kg, such as at least 18 mmol/kg, such as at least 20 mmol/kg, such as greater than about 25 mmol/kg, such as greater than about 30 mmol/kg, such as greater than about 40 mmol/kg, such as greater than about 50 mmol/kg. The terminal hydroxyl content is generally less than about 300 mmol/kg, such as less than about 200 mmol/kg, such as less than about 100 mmol/kg, such as less than about 60 mmol/kg. In one embodiment, the terminal hydroxyl group content ranges from 18 to 65 mmol/kg. In an alternative embodiment, the polyoxymethylene polymer may contain terminal hydroxyl groups in an amount less than 20 mmol/kg, such as less than 18 mmol/kg, such as less than 15 mmol/kg. For instance, the polyoxymethylene polymer may contain terminal hydroxyl groups in an amount from about 5 mmol/kg to about 20 mmol/kg, such as from about 5 mmol/kg to about 15 mmol/kg. For example, a polyoxymethylene polymer may be used that has a lower terminal hydroxyl group content but has a higher melt volume flow rate. The quantification of the hydroxyl group content in the polyoxymethylene polymer may be conducted by the method described in JP-A-2001-11143.

In addition to the terminal hydroxyl groups, the polyoxymethylene polymer may also have other terminal groups usual for these polymers. Examples of these are alkoxy groups, formate groups, acetate groups or aldehyde groups. According to one embodiment, the polyoxymethylene is a homo- or copolymer which comprises at least 50 mol-%, such as at least 75 mol-%, such as at least 90 mol-% and such as even at least 95 mol-% of —CH₂O-repeat units.

In one embodiment, a polyoxymethylene polymer with hydroxyl terminal groups can be produced using a cationic polymerization process followed by solution hydrolysis to remove any unstable end groups. During cationic polymerization, a glycol, such as ethylene glycol can be used as a chain terminating agent. The cationic polymerization can result in a bimodal molecular weight distribution containing low molecular weight constituents. In one particular embodiment, the low molecular weight constituents can be significantly reduced by conducting the polymerization using a heteropoly acid such as phosphotungstic acid as the catalyst. When using a heteropoly acid as the catalyst, for instance, the amount of low molecular weight constituents can be less than about 2 wt. %.

The polyoxymethylene polymer can have any suitable molecular weight. The molecular weight of the polymer, for instance, can be from about 4,000 grams per mole to about 200,000 g/mol. It is believed, however, that using a polyoxymethylene copolymer with a relatively high molecular weight can provide various advantages. For instance, higher molecular weight polymers may produce better physical properties of green bodies produced according to the present disclosure. For example, the polyoxymethylene polymer can have a molecular weight of greater than about 90,000 g/mol, such as greater than about 100,000 g/mol, and generally less than about 200,000 g/mol, such as less than about 150,000 g/mol.

The polyoxymethylene polymer present in the composition can generally have a melt flow index (MFI) ranging from about 20 g/10 min to about 200 g/10 min, as determined according to ISO 1133 at 190° C. and 2.16 kg. For example, the polyoxymethylene polymer may have a melt flow index of greater than about 30 g/10 min, such as greater than about 35 g/10 min, such as greater than about 40 g/10 min, such as greater than about 45 g/10 min, such as greater than about 50 g/10 min, such as greater than about 55 g/10 min, such as greater than about 60 g/10 min, such as greater than about 65 g/10 min. The melt flow index of the polyoxymethylene polymer can be less than about 150 g/10 min, such as less than about 100 g/10 min.

The polyoxymethylene polymer may be present in the binder composition in an amount of at least 70 wt. %, such as at least 80 wt. %, such as at least 85 wt. %, such as at least 90 wt. %, such as at least 95 wt. %. The polyoxymethylene polymer may be present in the binder composition in an amount of less than about 97 wt. %, such as in an amount less than about 90 wt. %

In accordance with the present disclosure, the polyoxymethylene polymer is combined with one or more plasticizers. In accordance with the present disclosure, the plasticizers selected for use in combination with the polyoxymethylene polymer generally include polyalkylene glycols. The use of one or more plasticizers can provide various benefits. For example, the one or more plasticizers can dramatically increase impact resistance of the binder composition and can increase the melt flow rate. Consequently, relatively high molecular weight polyoxymethylene polymers can be used in the binder composition of the present disclosure and still have the flow properties needed in order to produce articles with complicated shapes. In addition, the plasticizers incorporated into the binder composition can easily be removed from a green body through contact with one or more acids and/or through thermal degradation.

Polyalkylene glycols particularly well suited for use in the binder composition include polyethylene glycols, polypropylene glycols, and mixtures thereof. For example, in one embodiment, the plasticizer incorporated into the binder composition is a polyethylene glycol.

The molecular weight of the plasticizer can vary depending upon various factors including the characteristics of the polyoxymethylene polymer and the process conditions for producing shaped articles. In one aspect, the plasticizer or polyethylene glycol can have a relatively low molecular weight. For example, the molecular weight can be less than about 10,000 g/mol, such as less than about 8,000 g/mol, such as less than about 6,000 g/mol, such as less than about 4,000 g/mol, and generally greater than about 1000 g/mol, such as greater than about 2000 g/mol. In one embodiment, a polyethylene glycol plasticizer is incorporated into the binder composition that has a molecular weight of from about 2000 g/mol to about 5000 g/mol.

In another aspect, a plasticizer or polyethylene glycol can be selected that has a higher molecular weight. For example, the molecular weight of the plasticizer can be about 10,000 g/mol or greater, such as greater than about 20,000 g/mol, such as greater than about 30,000 g/mol, such as greater than about 35,000 g/mol, and generally less than about 100,000 g/mol, such as less than about 50,000 g/mol, such as less than about 45,000 g/mol, such as less than about 40,000 g/mol.

In still another aspect, the binder composition may include two different plasticizers. The first plasticizer can be a polyalkylene glycol, such as polyethylene glycol, having a relatively low molecular weight as described above, such as from about 1000 g/mol to about 10,000 g/mol. The second plasticizer incorporated into the binder composition, on the other hand, can be a plasticizer or polyethylene glycol having a higher molecular weight as described above. For example, the second plasticizer can have a molecular weight of from about 20,000 g/mol to about 50,000 g/mol. The weight ratio between the first plasticizer and the second plasticizer can also vary. For instance, the weight ratio between the first plasticizer and the second plasticizer can be from about 10:1 to about 1:5, such as from about 8:1 to about 1:2, such as from about 5:1 to about 1:1.

One or more plasticizers are generally contained in the binder composition in an amount greater than about 1% by weight, such as in an amount greater than about 2% by weight, such as in an amount greater than about 3% by weight, such as in an amount greater than about 4% by weight, such as in an amount greater than about 5% by weight, such as in an amount greater than about 6% by weight, such as in an amount greater than about 8% by weight, such as in an amount greater than about 10% by weight. The one or more plasticizers are present in the binder composition generally in an amount less than about 25% by weight, such as in an amount less than about 20% by weight, such as in an amount less than about 15% by weight, such as in an amount less than about 10% by weight, such as in an amount less than about 8% by weight.

In addition to one or more plasticizers, the binder composition can also contain a powder flow agent. The powder flow agent can be added to the binder composition so that the powder has fluid-like flow properties and that the individual particles do not stick or agglomerate together.

Powder flow agents which may be used, individually or in combination, are metal oxides, alkali-metal or alkaline-earth-metal salts or salts of other bivalent metal ions, such as Zn²⁺, of long-chain fatty acids, such as stearates, laurates, oleates, behenates, montanates and palmitates, and also amide waxes, montan waxes or olefin waxes.

In one aspect, the powder flow agent can be a metal oxide or a metal salt of a carboxylic acid, such as an alkali-metal salt or an alkaline-earth-metal salt of a carboxylic acid. The carboxylic acid, for instance, may be a stearate. For example, in one aspect, the powder flow agent is calcium stearate. Metal oxide particles that can be used as powder flow agents include aluminum oxide, silicon dioxide, and mixtures thereof. The alumina and silica can be fumed alumina and fumed silica. The d50 particle size of the metal oxide can be from about 1 micron to about 25 microns, such as from about 5 microns to about 18 microns, determined using laser diffraction according to ISO Test 13320.

When present, the powder flow agent can be added to the binder composition and incorporated into the individual particles in an amount greater than about 1% by weight, such as in an amount greater than about 2% by weight, such as in an amount greater than about 6% by weight, such as in an amount greater than about 8% by weight and generally in an amount less than about 25% by weight, such as in an amount less than about 20% by weight, such as in an amount less than about 15% by weight, such as in an amount less than about 12% by weight.

The polymer composition of the present disclosure can also optionally contain a stabilizer and/or various other additives. Such additives can include, for example, antioxidants, acid scavengers, UV stabilizers or heat stabilizers. In addition, the polymer composition may contain processing auxiliaries, for example adhesion promoters, or antistatic agents.

In one embodiment, the polymer composition may include a formaldehyde scavenger, such as a nitrogen-containing compound. Mainly, of these are heterocyclic compounds having at least one nitrogen atom as hetero atom which is either adjacent to an amino-substituted carbon atom or to a carbonyl group, for example pyridine, pyrimidine, pyrazine, pyrrolidone, aminopyridine and compounds derived therefrom. Advantageous compounds of this nature are aminopyridine and compounds derived therefrom. Any of the aminopyridines is in principle suitable, for example 2,6-diaminopyridine, substituted and dimeric aminopyridines, and mixtures prepared from these compounds. Other advantageous materials are polyamides and dicyane diamide, urea and its derivatives and also pyrrolidone and compounds derived therefrom. Examples of suitable pyrrolidones are imidazolidinone and compounds derived therefrom, such as hydantoines, derivatives of which are particularly advantageous, and those particularly advantageous among these compounds are allantoin and its derivatives. Other particularly advantageous compounds are triamino-1,3,5-triazine(melamine) and its derivatives, such as melamine-formaldehyde condensates and methylol melamine. Oligomeric polyamides are also suitable in principle for use as formaldehyde scavengers. The formaldehyde scavenger may be used individually or in combination.

Further, the formaldehyde scavenger can be a guanidine compound which can include an aliphatic guanamine-based compound, an alicyclic guanamine-based compound, an aromatic guanamine-based compound, a hetero atom-containing guanamine-based compound, or the like.

In one embodiment, the formaldehyde scavenger may be a copolyimide that is used alone or combined with another formaldehyde scavenger. The copolyamide can have a softening point of generally greater than about 120° C., such as greater than about 130° C., such as greater than about 140° C., such as greater than about 150° C., such as greater than about 160° C., such as greater than about 170° C. The softening point of the copolyamide may be less than about 210° C., such as less than about 200° C., such as less than about 190° C., such as less than about 185° C. The copolyamide may have a melt viscosity at 230° C. of greater than about 7 Pa s, such as greater than about 8 Pa s, such as greater than about 9 Pa s. The melt viscosity is generally less than about 15 Pa s, such as less than about 14 Pa s, such as less than about 13 Pa s. In one embodiment, the copolyamide is ethanol soluble. In one embodiment, the copolyamide may comprise a polycondensation product of polymeric fatty acids with aliphatic diamines. The copolyamide can generally be present in the composition in an amount greater than about 0.01% by weight, such as in an amount greater than about 0.03% by weight, such as in an amount greater than about 0.04% by weight. The copolyamide is generally present in an amount less than about 2% by weight, such as in an amount less than about 1% by weight, such as in an amount less than about 0.5% by weight, such as in an amount less than about 0.2% by weight, such as in an amount less than about 0.1% by weight.

In general, one or more formaldehyde scavengers can be present in the polymer composition in an amount ranging from about 0.005% by weight to about 2% by weight, such as in an amount ranging from about 0.0075% by weight to about 1% by weight based on the total weight of the polymer composition.

Still another additive that may be present in the composition is a sterically hindered phenol compound, which may serve as an antioxidant. Examples of such compounds, which are available commercially, are pentaerythrityl tetrakis[3-(3,5-di-tert-butyl-4-hydroxyphenyl)propionate] (IRGANOX® 1010, BASF), triethylene glycol bis[3-(3-tert-butyl-4-hydroxy-5-methylphenyl)propionate] (IRGANOX® 245, BASF), 3,3′-bis[3-(3,5-di-tert-butyl-4-hydroxyphenyl)propionohydrazide] (IRGANOX® MD 1024, BASF), hexamethylene glycol bis[3-(3,5-di-cert-butyl-4-hydroxyphenyl)propionate] (IRGANOX® 259, BASF), and 3,5-di-tert-butyl-4-hydroxytoluene (LOWINOX® BHT, Chemtura). The above compounds may be present in the polymer composition in an amount ranging from about 0.01% by weight to about 2% by weight based on the total weight of the polymer composition. For example, a sterically hindered phenol can be present in the composition in an amount greater than about 0.08% by weight, such as in an amount of greater than about 0.1% by weight, such as in an amount of greater than about 0.2% by weight, and generally in an amount less than about 1.8% by weight, such as in an amount less than about 1% by weight, such as in an amount less than about 0.5% by weight.

In one embodiment, an acid scavenger may be present. The acid scavenger may comprise, for instance, an alkaline earth metal salt. For instance, the acid scavenger may comprise a calcium salt, such as a calcium salt of a fatty acid, such as a calcium citrate (e.g. tricalcium citrate) or calcium stearate (e.g. calcium 12 hydroxy stearate). In one embodiment, the acid scavenger may comprise a metal carbonate, such as calcium carbonate. The acid scavenger may have an average particle size of from about 0.5 microns to about 20 microns, including all increments of 1 micron therebetween. In one aspect, the average particle size can be greater than about 3 microns, such as greater than about 5 microns, such as greater than about 7 microns, such as greater than about 9 microns, and generally less than about 18 microns, such as less than about 15 microns, such as less than about 13 microns.

The acid scavenger may be present in an amount of at least about 0.01 wt. %, such as at least about 0.05 wt. %, such as at least about 0.06 wt. %. In one embodiment, greater amounts of an acid scavenger are used, such as when the acid scavenger is a carbonate. For example, the acid scavenger can be present in an amount greater than about 2 wt. %, such as greater than about 5 wt. %, such as greater than about 7 wt. %. The acid scavenger is generally present in an amount less than about 10 wt. %, such as less than about 7 wt. %, such as less than about 5 wt. %, such as less than about 1 wt. %, such as less than about 0.75 wt. %, such as less than about 0.5 wt. %, such as less than about 0.1 wt. %, wherein the weight is based on the total weight of the respective polymer composition.

In one embodiment, a nucleating agent may be present. The nucleating agent may increase may comprise an oxymethylene terpolymer. In one particular embodiment, for instance, the nucleating agent may comprise a terpolymer of butanediol diglycidyl ether, ethylene oxide, and trioxane. In one embodiment, the terpolymer nucleating agent can have a relatively small particle size, such as having a d50 particle size of less than about 1 micron, such as less than about 0.8 microns, such as less than about 0.6 microns, such as less than about 0.4 microns, and generally greater than 0.01 microns. Other nucleating agents that may be used include a polyamide, boron nitride, or a talc. The polyamide nucleating agent may be PA6 or PA12. The nucleating agent may be present in the composition in an amount of at least about 0.01 wt. %, such as at least about 0.05 wt. %, such as at least about 0.1 wt. %, such as at least about 0.3 wt. % and less than about 2 wt. %, such as less than about 1.5 wt. %, such as less than about 1 wt. %, such as less than about 0.8 wt. %, wherein the weight is based on the total weight of the respective polymer composition.

In one embodiment, lubricants may be present. The lubricant may comprise a polymer wax composition. In one embodiment, a fatty acid amide such as ethylene bis(stearamide) may be present. In an alternative embodiment, the lubricant may comprise a polyalkylene glycol that has a relatively low molecular weight in relation to the plasticizer. Lubricants may generally be present in the polymer composition in an amount of at least about 0.01 wt. %, such as at least about 0.05 wt. %, such as at least about 0.1 wt. %, such as at least about 0.2 wt. % and less than about 1 wt. %, such as less than about 0.75 wt. %, such as less than about 0.5 wt. %, wherein the weight is based on the total weight of the respective polymer composition.

Any of the above additives can be added to the binder composition alone or combined with other additives. In general, each additive is present in the polymer composition in an amount less than about 5% by weight, such as in an amount ranging from about 0.005% by weight to about 2% by weight, such as in an amount ranging from about 0.0075% by weight to about 1% by weight, such as from about 0.01% by weight to about 0.5% by weight based on the total weight of the binder composition.

All the additives and components described above are incorporated into the binder composition and can be melt blended with the polyoxymethylene polymer to produce the particles that make up the powder.

In order to form the binder composition of the present disclosure, in one aspect, the components of the polymer composition can be mixed together and then melt blended. For instance, the components can be melt blended in an extruder. Processing temperatures can vary depending upon the type of polyoxymethylene polymer chosen for use in the application. In one embodiment, processing temperatures can be from about 165° C. to about 200° C.

Extruded strands can be produced which are then pelletized. The pelletized compound can optionally be ground to a suitable particle size and to a suitable particle size distribution. The pelletized compound, however, is well suited for being combined with the sinterable particles in an extruder.

The binder composition of the present disclosure is formulated to have a relatively high melt flow rate. The one or more plasticizers, for instance, increase the melt flow rate in comparison to the melt flow rate of the polyoxymethylene polymer alone. The melt flow rate of the binder composition is generally greater than about 40 g/10 min, such as greater than about 48 g/10 min, such as greater than about 50 g/10 min, such as greater than about 55 g/10 min, such as greater than about 60 g/10 min, such as greater than about 65 g/10 min, such as greater than about 70 g/10 min, such as greater than about 75 g/10 min, such as greater than about 80 g/10 min, such as greater than about 90 g/10 min, such as greater than about 100 g/10 min, such as greater than about 110 g/10 min, such as greater than about 120 g/10 min, such as greater than about 130 g/10 min, such as greater than about 140 g/10 min, such as greater than about 150 g/10 min, and generally less than about 400 g/10 min, such as less than about 200 g/10 min.

The binder composition of the present disclosure has many beneficial properties. For example, not only is the composition easily removed from green bodies using acid catalyzation, but the composition also has excellent physical properties. For example, the binder composition has great toughness characteristics and impact resistance. For example, when tested according to the Charpy notched impact strength test, the binder composition can display an impact resistance of greater than about 5 kJ/m², such as greater than about 6 kJ/m², such as greater than about 7 kJ/m², such as greater than about 8 kJ/m², and generally less than about 20 kJ/m². The Charpy unnotched impact strength resistance of the polymer composition can generally be greater than about 150 kJ/m², such as greater than about 160 kJ/m², such as greater than about 170 kJ/m², and generally less than about 250 kJ/m².

In order to produce three-dimensional articles in accordance with the present disclosure, the binder composition as described above is combined with inorganic sinterable particles. In general, any suitable sinterable particles can be used in processes according to the present disclosure. The sinterable particles, for instance, can include elemental metal powders, metal alloy powders, metal carbonyl powders, ceramic powders, and mixtures thereof.

The sinterable powder portion of the feedstock is what provides the mechanical properties to the finished product. For instance, when produced from a metal, the finished part displays similar properties as the metal that the powder is made from. In principle, any metal powder can be used to produce products in accordance with the present disclosure as long as the powder particles are relatively small, mix well with polymers, sinter to a sufficiently high density, and have enough melting and sintering temperature to not interfere with the binding process.

Examples of metals which may be present in powder form include aluminum, iron, especially iron carbonyl powder, chromium, cobalt, copper, nickel, silicon, titanium and tungsten. Examples of pulverulent metal alloys include high- or low-alloy steels and metal alloys based on aluminum, iron, titanium, copper, nickel, tungsten or cobalt.

These include both powders of already finished alloys, for example superalloys such as IN7130, GMR 235 and IN 100, and the alloys known from magnet technology with the main constituents Nd—Fe—B and Sm—Co, and powder mixtures of the individual alloy constituents. The metal powders, metal alloy powders and metal carbonyl powders can also be used in a mixture.

Suitable inorganic powders are also oxidic ceramic powders such as Al₂O₃, ZrO₂, Y₂O₃, but also nonoxidic ceramic powders such as SiC, Si₃N₄, and more complex oxide powders such as NiZnFe₂O₄, and also inorganic color pigments such as CoAl₂O₄.

In one aspect, the sinterable particles are stainless steel particles. Other commonly used alloys include tool steel, copper, cemented carbides, titanium, and other refractory metals.

The inorganic sinterable particles can generally have a volume based median particle size of from about 0.1 microns to about 100 microns, such as from about 0.2 microns to about 50 microns. In other aspects, the inorganic sinterable particles have a volume based median particle size of less than about 30 microns, such as less than about 25 microns, such as less than about 20 microns, such as less than about 15 microns, such as less than about 10 microns, such as less than about 8 microns, such as less than about 5 microns. Smaller particles can be desired in some applications. Smaller particles, for instance, can increase the packing density and improve homogeneity in the feedstock. Smaller particles also provide a smoother surface finish as well as being less abrasive to the injection molding machine. Smaller particles also have a greater surface area and consequently higher surface energy. High surface energy is favorable since it drives the sintering mechanism. Particle size can be determined using a laser scattering particle size distribution analyzer (e.g., Horiba LA910).

In one embodiment, the sinterable particles may have a mean particle size such that at least about 90% of the particles pass through a 150 mesh (105 microns), in some embodiments at least about 95%, and in some embodiments, at least about 98%. Stainless steel particles may have a mean particle size such that at least about 90% of the particles pass through a 325 mesh (44 microns), in some embodiments at least about 95%, and in some embodiments, at least about 98%.

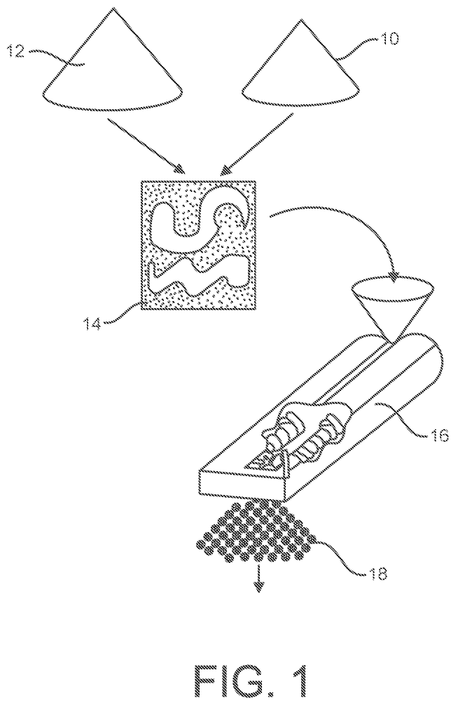

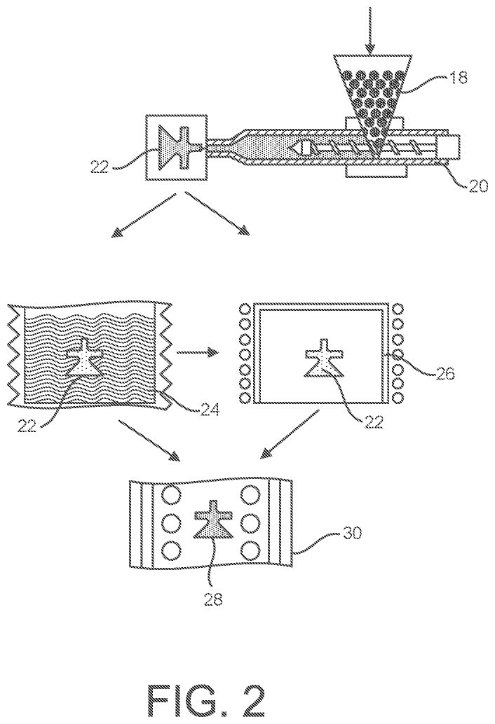

Referring to FIGS. 1 and 2, one embodiment of a process for producing shaped articles in accordance with the present disclosure is illustrated. As shown in FIG. 1, a binder composition 10 made in accordance with the present disclosure is combined with inorganic sinterable particles 12. The combined composition generally contains the inorganic sinterable powder in an amount greater than about 50% by weight, such as in an amount greater than about 60% by weight, such as in an amount greater than about 70% by weight, such as in an amount greater than about 80% by weight, such as in an amount greater than about 85% by weight, such as in an amount greater than about 90% by weight, and generally in an amount less than about 98% by weight, such as in an amount less than about 95% by weight, such as in an amount less than about 92% by weight.

The composition containing the inorganic sinterable particles and the binder composition are fed to a premixing device 14 and then into an extruder 16. Alternatively, the binder composition and the inorganic sinterable particles can be fed to the extruder 16 at different locations for melt blending the two components together. In the extruder 16, the inorganic sinterable particles and the binder composition are melt blended together to form pellets 18. The pellets 18 represent a feedstock for feeding into an injection molding process.

The binder composition of the present disclosure when combined with the inorganic sinterable powders has been found to dramatically improve the toughness of the resulting pellets 18 in conjunction with a decrease in stiffness. For instance, it was discovered that the binder composition of the present disclosure produces the pellets 18 having a relatively high ductility. The composition that forms the pellets 18, for instance, can have a bending deflection of greater than about 1.6 mm, such as greater than about 2 mm, such as greater than about 3 mm, such as greater than about 4 mm, and generally less than about 10 mm.

Referring to FIG. 2, one embodiment of an injection molding and sintering process is illustrated. As shown, the composition of the present disclosure in the form of the pellets 18 is fed into an injection molding device 20. The injection molding device, for instance, can be a screw and piston injection molding machine. A shaped article 22 is formed generally at temperatures of from about 170° C. to about 220° C., such as from about 180° C. to about 200° C. The pressures within the injection molding device 20 can be greater than about 3000 kPa, such as greater than about 5000 kPa, such as greater than about 10,000 kPa, such as greater than about 12,000 kPa, and generally less than about 25,000 kPa, such as less than about 20,000 kPa, such as less than about 18,000 kPa. The mold can be at a temperature generally from about 50° C. to about 180° C., such as from about 65° C. to about 145° C.

The injection molding device 20 produces a green body 22 that is then subjected to a debinding process. As shown in FIG. 2, debinding can occur using one or more acids in a chamber 24 and/or can occur using thermal debinding in an oven 26. In one embodiment, the green body 22 is first subjected to acid catalyzed chain scission and then subjected to thermal debinding prior to sintering.

The catalytic debinding occurring in chamber 24 can be affected by acid treatment by contacting the green body 22 with one or more acids. The acids can either be in liquid form or in a gaseous state. Suitable acids that may be used include nitric acid, organic acids such as formic acid, acetic acid, oxalic acid, or trifluoroacetic acid, a boron fluoride, hydrochloric acid, or other hydrogen halide acids. In one embodiment, the acid can be a phthalic acid. Another acid that may be used is benzoic acid. In still another embodiment, the green body can be subjected to a mixture of phthalic acid and benzoic acid.

When the acid is in liquid form, the temperature during debinding can be from about 23° C. to about 70° C. When the one or more acids are in a gaseous state, however, the temperature can be in the range of from about 80° C. to about 180° C.

The green body 22 can be contacted with one or more acids for a time sufficient to remove greater than 50% of the binder composition, such as greater than about 70% of the binder composition, such as greater than about 80% of the binder composition, such as greater than about 90% of the binder composition, such as greater than about 95% of the binder composition, such as greater than about 98% of the binder composition. The green body 22, for instance, can be contacted with one or more acids for a time of from about 20 minutes to about 24 hours, such as from about 2 hours to about 10 hours. During acid catalyzed chain scission, the one or more acids attack the backbone of the polyoxymethylene polymer. In addition, the one or more acids act as catalysts for hydrolysis which un-zip formaldehyde molecules in a stepwise manner from the chain. In addition, end groups and blocking groups contained within the polyoxymethylene polymer are reduced to glycols, such as ethylene glycol. These components are reduced into a vaporized state and can then be easily removed from the green body 22. In one aspect, as shown in FIG. 2, the green body 22 can be submerged in an acidic solution within the chamber 24.

After acid catalyzed debinding, residual amounts of the binder composition may still remain within the green body 22. Optionally, the green body 22 can be fed to an oven or furnace 26 for a thermal debinding step. During thermal debinding, the green body 22 is dried and subjected to temperatures sufficient to remove virtually any remaining or residual binder composition. For instance, the temperature within the furnace or oven 26 can be greater than about 135° C., such as greater than about 145° C., such as greater than about 155° C., and generally less than about 200° C., such as less than about 180° C. in an atmosphere containing oxygen.

After optionally subjecting the green body 22 to thermal debinding, a brown body 28 is then subjected to a sintering process within a sintering chamber 30. The atmosphere of the sintering chamber and the pressure can depend upon various factors including the type of sinterable particles contained within the brown body 28. In general, the brown body 28 is gradually heated to a sintering temperature of from about 500° C. to about 700° C. over a period of time of from about 20 minutes to about 3 hours. Once at the sintering temperature, the brown body 28 is held at the temperature for at least 10 minutes, such as at least 20 minutes, such as least 30 minutes, and generally less than about 5 hours, such as less than about 3 hours.

Once the particles have sintered together, the article is cooled. In one embodiment, the finished article can be cooled very rapidly. After sintering, the article can be used as desired or fed into further treatment processes. For example, the article can be subjected to hardening, austenitization, annealing, hardening, heat treatment, carburization, nitriding, steam treatment, or the like.

The present disclosure may be better understood with reference to the following example.

### Example

Various binder compositions were formulated in accordance with the present disclosure. The binder compositions were combined with sinterable stainless steel particles and tested for physical properties.

The following physical properties were tested on the samples.

| | |
|---|---|
| Physical Properties | Melt Volume Rate (MVR) |
| | (cm³/10 min) |
| | ISO 1133 |
| | MVR Test |
| | Temperature (° C.) |
| | ISO 1133 |
| | MVR Test Load |
| | (kg) |
| | ISO 1133 |
| Mechanical Properties | Tensile Modulus |
| | (1 mm/min) |
| | (MPa) |
| | ISO 527-2/1A |
| | Tensile Stress at yield |
| | (50 mm/min) |
| | (MPa) |
| | ISO 527-2/1A |
| | Tensile Stress at yield |
| | (50 mm/min) |
| | (%) |
| | ISO 527-2/1A |
| | Break Strain |
| | (50 mm/min) |
| | (%) |
| | ISO 527-2/1A |
| | Flexural Modulus, |
| | Flexural Strength, |
| | 23° C. (MPa) |
| | ISO 178 |
| | Charpy Unnotched |
| | or Notched |
| | Impact Strength, |
| | 23° C. (kJ/m²) |
| | ISO 179/1eA |
| Thermal Properties | DTUL at 1.8 |
| | MPa (° C.) |
| | ISO 75-1, −2 |

Three binder compositions were formulated in accordance with the present disclosure as follows.

Sample No. 1: 93% by weight of a polyoxymethylene copolymer containing 3.58% by weight dioxolane, having an —OCH₃ endcap content of 33 mmol/kg, having a molecular weight of approximately 110,000 g/mol, and an MFR of 42 g/10 min; combined with 7% by weight of a polyethylene glycol having a molecular weight of 3350 g/mol.

Sample No. 2: 95% by weight of a polyoxymethylene copolymer containing 3.58% by weight dioxolane, having an —OCH₃ endcap content of 33 mmol/kg, having a molecular weight of approximately 110,000 g/mol, and an MFR of 45 g/10 min; combined with 5% by weight of a polyethylene glycol having a molecular weight of 35,000 g/mol.

Sample No. 3: 86.78% by weight of a polyoxymethylene copolymer containing 3.58% by weight dioxolane, having an —OH endcap content of 54 mmol/kg and an MFR of 45 g/10 min; combined with 12% by weight of a polyethylene glycol having a molecular weight of 35,000 g/mol, 0.3% by weight of a phenol antioxidant, 0.07% by weight calcium hydroxy stearate, 0.05% by weight copolyamide, 0.5% by weight terpolymer nucleating agent, and 0.3% by weight ethylene bis(stearamide).

The above formulations were compared to a binder composition only containing the polyoxymethylene polymer described in Sample No. 2 above (hereinafter Sample No. 4).

The above three samples were tested for various properties and the following results were obtained:

| | Sample | Sample | Sample | Sample |
|---|---|---|---|---|
| | No. 1 | No. 2 | No. 3 | No. 4 |
| MI (g/10 min) | 63 | 52 | 57 | 45 |
| MP | 166 | 166.7 | — | 167.4 |
| Density (g/cc) | 1.39 | 1.40 | — | 1.40 |
| Flex modulus | 2096 | 2357 | 2064 | 2789 |
| (MPa) | | | | |
| Flex strength | 53.26 | 61.28 | 53 | 74.8 |
| (MPa) | | | | |
| Tensile Modulus | 2247 | 2528 | 2227 | 2912 |
| (MPa) | | | | |
| Yield Stress | 52.88 | 49.97 | 48 | 65.18 |
| (MPa) | | | | |
| Yield Strain (%) | 8.17 | 7.51 | 9 | 7.01 |
| Break Strain (%) | 14.66 | 39.95 | 40 | 14.01 |
| Charpy notched | 4.8 | 5.3 | 3.2 | 4.8 |
| (kJ/m²) | | | | |
| Unnotched | 114.2 | 171.1 | 149 | 130.3 |
| Charpy (kJ/m²) | | | | |
| DTUL @ 1.8 | 82.6 | 93.6 | — | 103.6 |
| MPa (° C.) | | | | |

As shown above, combining a polyoxymethylene polymer with a plasticizer in accordance with the present disclosure can dramatically improve impact resistance and increase melt flow rate.

Sample No. 1 and Sample No. 2 above were combined with stainless steel particles having a volume based median particle size of about 11 microns. The resulting composition contained the stainless steel particles in an amount of 90% by weight.

The above formulations were then melt blended together and tested for melt flow rate and bending deflection. The following results were obtained:

| | Sample | Sample |
|---|---|---|
| Properties | No. 1 | No. 2 |
| MFR of binder composition | 63 | 52 |
| (g/10 min) | | |
| MFR of binder and stainless | 850 | 580 |
| steel feedstock (g/10 mm) | | |
| Bending deflection (mm) | 1.691 | 4.916 |

As shown above, when the binder composition of the present disclosure is combined with metal particles, the resulting composition has excellent ductility as evidenced by the bending deflection properties.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A binder composition for combining with inorganic sinterable particles for injection molding articles comprising:
polymer particles comprised of a polymer composition comprising a polyoxymethylene polymer blended with a plasticizer, the plasticizer comprising a polyalkylene glycol, the polymer composition having a melt flow rate of greater than about 48 g/10 min.

2. A binder composition as defined in claim 1, wherein the plasticizer comprises a polyethylene glycol.

3. A binder composition as defined in claim 1, wherein the polyalkylene glycol has a molecular weight of from about 1000 g/mol to about 10,000 g/mol.

4. A binder composition as defined in claim 1, wherein the polyalkylene glycol has a molecular weight of from about 20,000 g/mol to about 50,000 g/mol.

5. A binder composition as defined in claim 1, wherein the plasticizer comprises a first polyethylene glycol and a second polyethylene glycol, the first polyethylene glycol having a molecular weight of from about 1000 g/mol to about 10,000 g/mol, the second polyethylene glycol having a molecular weight of from about 20,000 g/mol to about 50,000 g/mol.

6. A binder composition as defined in claim 1, wherein the plasticizer is present in the polymer composition in an amount from about 2% to about 25% by weight.

7. A binder composition as defined in claim 1, wherein the polymer composition has a Charpy notched impact strength of greater than about 3 kJ/m² and has a Charpy unnotched impact strength of greater than about 140 kJ/m².

8. A binder composition as defined in claim 1, wherein the polymer composition has a melt flow rate of greater than about 50 g/10 min.

9. A binder composition as defined in claim 1, wherein the polyoxymethylene polymer comprises a polyoxymethylene copolymer containing a dioxolane comonomer, the dioxolane being present in the copolymer in an amount from about 3.3% to about 4% by weight.

10. A binder composition as defined in claim 1, wherein the polyoxymethylene polymer includes —OCH₃ endcaps, the —OCH₃ endcaps being present in an amount less than about 50 mmol/kg and generally in an amount greater than about 10 mmol/kg.

11. A binder composition as defined in any of claim 1, wherein the polyoxymethylene polymer includes —OH terminal groups, the —OH terminal groups being present in the polyoxymethylene polymer in an amount greater than about 20 mmol/kg and generally in an amount less than about 100 mmol/kg.

12. A binder composition as defined in claim 1, wherein the polyoxymethylene polymer has a molecular weight of greater than about 90,000 g/mol and generally less than about 200,000 g/mol.

13. A binder composition as defined in claim 1, wherein the polyxoxymethylene polymer is present in the polymer composition in an amount from about 80% to about 98% by weight.

14. A binder composition as defined in claim 1, further containing a lubricant, an acid scavenger, and an antioxidant.

15. A binder composition as defined in claim 1, further containing a copolyamide and a nucleating agent.

16. A composition for forming injection molded articles comprising:
an inorganic sinterable powder comprising metal particles, ceramic particles, or mixtures thereof, the inorganic sinterable powder being present in the composition in an amount from about 50% to about 95% by weight; and
a binder composition as defined in claim 1.

17. A composition as defined in claim 16, wherein the inorganic sinterable powder and binder have been melt blended together.

18. A composition as defined in claim 17, wherein the composition is in the form of pellets.

19. A composition as defined in claim 16, wherein the inorganic sinterable powder comprises metal particles, the metal particles containing aluminum, iron, chromium, cobalt, copper, nickel, silicon, titanium, tungsten, or mixtures thereof.

20. A composition as defined in claim 16, wherein the inorganic sinterable powder comprises metal particles, the metal particles comprise stainless steel particles, tool steel particles, copper particles, cemented carbide particles, titanium particles, or mixtures thereof.

21. A composition as defined in claim 16, wherein the inorganic sinterable powder has a volume based median particle size of from about 0.1 microns to about 45 microns and wherein the composition displays a bending deflection of greater than about 1.6 mm and generally less than about 10 mm.

22. A process for producing shaped articles comprising:
injection molding an article from the composition as defined in claim 16 to form a green body;
removing a substantial portion of the binder by contacting the green body with an acid to form a brown body; and
subsequently sintering the inorganic particles in the brown body to form the shaped article.
